(19) United States
(12) Patent Application Publication
(10) Pub. No.: US 2005/0276736 A1
(43) Pub. Date: Dec. 15, 2005

(54) Toothbursh storage unit

(76) Inventor: Ron P. Miller, Windsor (CA)

Correspondence Address: BUTZEL LONG, 350 SOUTH MAIN STREET, SUITE 300, ANN ARBOR, MI, 48104, US

(21) Appl. No.: 11/129,842

(22) Filed: May 16, 2005

Related U.S. Application Data
(60) Provisional application No. 60/579,427, filed on Jun. 14, 2004.

(51) Int. Cl. A46B 9/04; B08B 3/00

(52) U.S. Cl. 422/300; 134/84

(57) ABSTRACT

A toothbrush holder designed to be used in combination with disposable cleaning fluid cartridges. The toothbrush holder includes a main storage compartment that is divided into compartments that are configured to receive the disposable cleaning fluid cartridges and a storage area. The main storage compartment is provided with a cover that includes apertures that are aligned over the disposable cleaning fluid cartridge receiving compartments so that toothbrushes can be inserted though the apertures in the cover and into disposable cleaning fluid cartridges. The disposable cleaning fluid cartridges are sized and complementary shaped to be received in the disposable cleaning fluid cartridge receiving compartments. The disposable cleaning fluid cartridges include openable sealed ends and are filled with a cleaning solution. Either the apertures in the cover or the disposable cleaning fluid cartridges are provided with sealing members though which toothbrushes can be inserted.

### TECHNICAL FIELD

The present invention relates to a storage unit for toothbrushes and, more specifically, to a sanitary storage unit for storing toothbrushes with the bristle end of the toothbrushes immersed in a sanitary liquid contained in disposable cartridges.

### BACKGROUND ART

Toothbrushes are commonly stored in any number of ways, many of which are unsightly and/or unsanitary. Often, toothbrushes are stored uncovered on countertops, in drawers, or in unsanitized holders where they are exposed to germs and contaminants in the air. Toothbrushes stored on the countertop, whether in or out of a particular toothbrush holder, may leave toothpaste residue on the countertop or on the holder and in general, toothbrushes stored in this manner may lead to a cluttered countertop appearance.

The general problem of unsanitary toothbrush storage has been recognized by many in the past, who have devised any number of toothbrush holders designed to sanitize the toothbrushes by immersing the bristles in a sanitizing liquid, exposing them to ultraviolet light, or exposing them to a sanitizing gas. Many such devices are complicated or bulky. Those that provide for soaking toothbrushes in sanitizing liquids do not allow for easy replenishment of the sanitizing liquid or washing of the reservoir for the sanitizing liquid.

Ordinary toothbrush holders have the potential of spreading diseases from one user, e.g. one family member, to another. In this regard, it is well recognized that toothbrushes provide a potential breeding ground for bacteria, particularly when not all contaminants are removed from a toothbrush by rinsing. Moreover, bathrooms are generally maintained at a high temperature and humidity levels which contributes to the growth of germs on toothbrushes.

Toothbrush holders such as racks, cups and the like can hold a group of toothbrushes in close, frequently touching, proximity. During periods of illness, exposed toothbrushes in such holders promote germ transfer from one person to another.

The present invention provides a storage unit for toothbrushes in which the bristle ends of the toothbrushes are immersed in a sanitary liquid contained in disposable cartridges. The storage unit of the present invention is convenient to use and promotes oral hygiene and the overall health and well being of the toothbrush users.

### DISCLOSURE OF THE INVENTION

According to various features, characteristics and embodiments of the present invention which will become apparent as the description thereof proceeds, the present invention provides a toothbrush holder designed to be used in combination with disposable cleaning fluid cartridges. The toothbrush holder includes a main storage compartment that is divided into compartments that are configured to receive the disposable cleaning fluid cartridges and a storage area. The storage area is configured to receive a plurality of the disposable cleaning fluid cartridges. The main storage compartment is provided with a cover that includes apertures that are aligned over the disposable cleaning fluid cartridge receiving compartments so that toothbrushes can be inserted though the apertures in the cover and into disposable cleaning fluid cartridges. The disposable cleaning fluid cartridges are sized and complementary shaped to be received in the disposable cleaning fluid cartridge receiving compartments. The disposable cleaning fluid cartridges include openable sealed ends and are filled with a cleaning solution. Either the apertures in the cover or the disposable cleaning fluid cartridges are provided with sealing members though which toothbrushes can be inserted.

In one embodiment the toothbrush holder is provided with a bracket by which it can be mounted to a vertical surface such as a wall or side of a cabinet.

In further embodiments the toothbrush holder includes a base that is provided beneath the main storage compartment which base extends beyond at least one side of the main storage compartment. The base includes an outer wall that defines at least one compartment configured to receive a base of a battery operated or electric toothbrush.

### BRIEF DESCRIPTION OF DRAWINGS

The present invention will be described with reference to the attached drawings which are given as non-limiting examples only, in which:

FIG. 1 is a cross-sectional side view of a toothbrush storage unit according to one embodiment of the present invention.

FIG. 2 is a top planar view of the main storage compartment of a toothbrush storage unit according to one embodiment of the present invention.

FIG. 3 is a cross-sectional side view of the main storage compartment of FIG. 2.

FIG. 4 is a side planar view of a disposable fluid cartridge according to one embodiment of the present invention.

FIG. 5 is a top planar view of a cover for a main storage compartment according to one embodiment of the present invention.

FIG. 6 is a planar side view of the cover of FIG. 5.

FIG. 7 is a top planar view of a base of a toothbrush storage unit according to one embodiment of the present invention.

FIG. 8 is a side planar view of an optional wall mountable side for the base of FIG. 7.

### BEST MODE FOR CARRYING OUT THE INVENTION

The present invention is directed to storage units for toothbrushes which storage units are configured to provide for storing toothbrushes so that the bristles of the toothbrushes are immersed in a solution (referred to herein as a “cleaning solution”) such as a mouthwash, an antiseptic liquid, a germicidal liquid, an antibacterial liquid, a solution of dilute hypochlorite, a dilute solution of hydrogen peroxide or a combination thereof. The cleaning solution is provided in disposable cartridges. The toothbrush storage units of the present invention are configured to hold at least one of the cleaning solution cartridges in a “use” position in which a toothbrush can be received in the cleaning solution cartridge(s). Additional cleaning solution cartridges can be placed in a storage area of the toothbrush storage units. In addition to being disposable, the cleaning solution cartridges are removable and replaceable in both the “use” and stored positions.

The cleaning solution cartridges come at least partially filled with the cleaning solution(s) and are sealed at their upper ends in a manner which allows the sealed ends to be opened or ruptured by hand before or after the cleaning solution cartridges are placed in the “use” position in the toothbrush storage units.

The toothbrush storage units of the present invention provide a convenient manner to store manual toothbrushes, bases and brush heads for electric and battery operated toothbrushes and the cleaning solution cartridges. In addition to a main storage compartment that includes the “use” positions for the cleaning fluid cartridges and the storage area, the toothbrush storage units are include a base having outer walls and divider walls which define compartments that are sized to support the bases of electric or battery operated toothbrushes.

The main storage compartment is provided with a cover that includes apertures through which tooth brushes can be inserted so as to be receive in cleaning fluid cartridges held in the “use” position(s) in the main storage compartment. The either the apertures of the cover or the cleaning fluid cartridges themselves are provided with sealing members that allow the toothbrushes to be inserted there through.

The toothbrush storage units of the present invention can either be placed on a surface such as a bathroom counter top or optionally mounted on a vertical surface such as a wall or side of a cabinet.

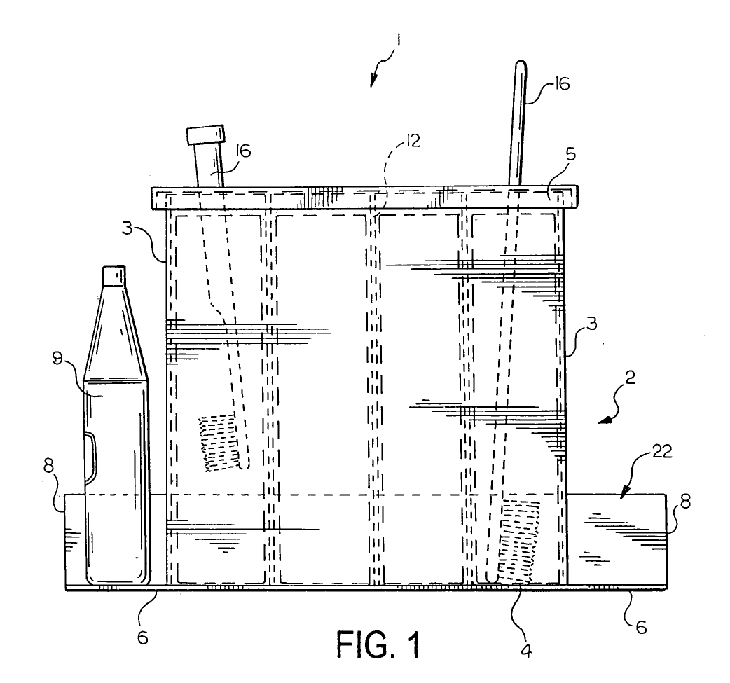

FIG. 1 is a cross-sectional side view of a toothbrush storage unit according to one embodiment of the present invention. The toothbrush storage unit 1 depicted in FIG. 1 includes a main storage compartment 2 that has outer walls 3 a base 4 and a cover 5. In the embodiment of the toothbrush storage unit depicted in FIG. 1 the main storage compartment 2 has a rectangular shape. In alternative embodiments that are mentioned below the main storage compartment 2 and overall device can have any desired shape. The base 4 of the toothbrush storage unit 1 includes extensions 5 that extend outward beyond one or more sides of the main storage compartment 2 to form a holder(s) for the bases 9 of electric or battery operated toothbrushes (one depicted). The extensions 6 include outer walls 8 which form define compartments that can be sized to support the bases 9 of electric or battery operated toothbrushes as depicted.

The main storage compartment 2 can be divided into vertical compartments that are sized to receive cleaning solution cartridges 10 therein. According to alternative embodiments the entire main storage compartment 2 can be divided into compartments or only a portion therefore. In the embodiment of the invention depicted in FIGS. 1-3 only the corner areas of the main storage compartment 2 are divided into compartments 11 which are configured to receive cleaning fluid cartridges 10. The central portion 12 of the main storage compartment 2 is open and can be used to store extra cleaning fluid cartridges 10.

The toothbrush storage unit 1 includes a removable or openable cover 5. The cover 5 includes flexible sealing elements 15 that are configured to be positioned over compartments 11 into which cleaning fluid cartridges 10 are placed so that toothbrushes 16 can be pushed through the sealing elements 15 and into the underlying cleaning fluid cartridges 10 and cleaning fluid therein as depicted in FIG. 1.

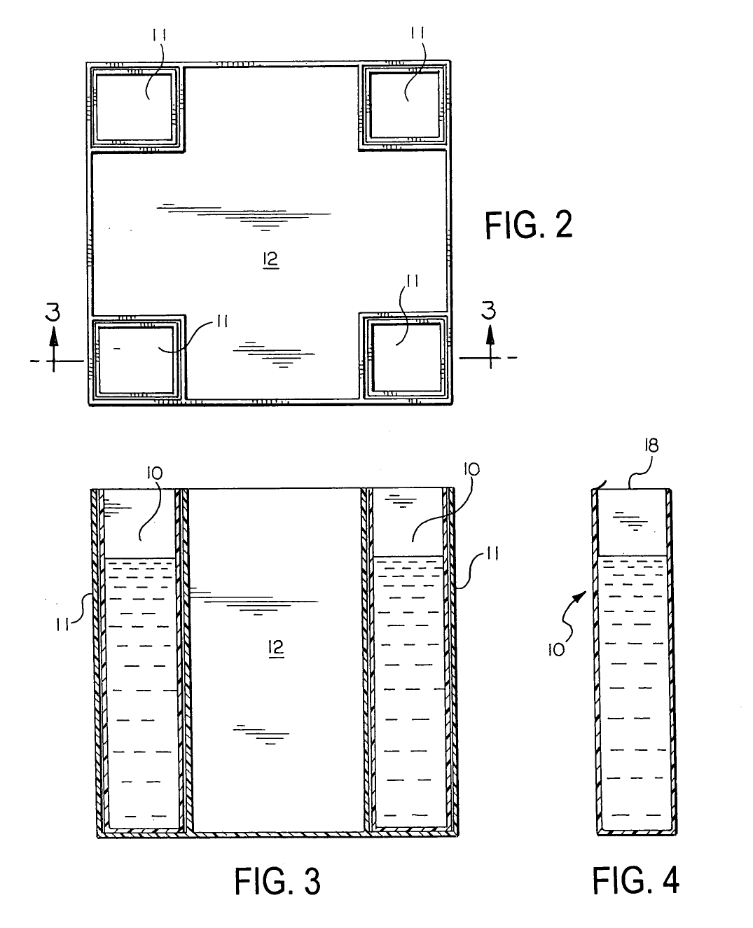

FIG. 2 is a top planar view of the main storage compartment of a toothbrush storage unit according to one embodiment of the present invention. In FIG. 2 compartments 11 are provided in the corners of the main storage compartment 2 and the central area 12 between the compartments 11 is open and can be used to store extra cleaning fluid cartridges 10 or other bathroom items. The main storage compartment 2 depicted in FIG. 2 has a square cross-sectional area. In alternative embodiments the main storage compartment 2 (and overall toothbrush storage unit) can have any desired cross-sectional shape including rectangular, circular, polygonal, or any curved or compound shapes.

FIG. 3 is a cross-sectional side view of the main storage compartment of FIG. 2. FIG. 3 depicts how the inner cross-sectional shape of the compartments 11 are complementary shaped and slightly larger than the corresponding cross-sectional shape of the cleaning fluid cartridges 10 for that the cleaning fluid cartridges 11 can be held vertically in the compartments 10. Although the compartments 11 and cleaning fluid cartridges 10 are depicted as having square cross-sectional shapes in FIGS. 1-4, in other embodiments of the present invention the compartments 11 and cleaning fluid cartridges 10 can have any desired cross-sectional shape including rectangular, circular, polygonal, or any curved or compound shapes.

FIG. 4 is a side planar view of a disposable fluid cartridge according to one embodiment of the present invention. The cleaning fluid cartridge 10 is filled with a solution to a level that is sufficient to enable at least the bristles of a toothbrush to be immersed therein when the cartridge 10 is positioned in one of the compartments 11 of the toothbrush storage unit 1 of the present invention. The top of the cleaning fluid cartridge 10 can be a removable foil, plastic or rubber film or sheet 18 that can be ripped or pulled off. In further embodiments other closures such as threaded caps, press fit caps, lids, plugs, etc. could be used to initially seal the cleaning fluid cartridges 10. In a further alternative embodiment the cleaning fluid cartridges 10 could be provided with flexible sealing elements 15 through which toothbrushes can be pushed into the cleaning fluid contained in the cleaning fluid cartridges 10.

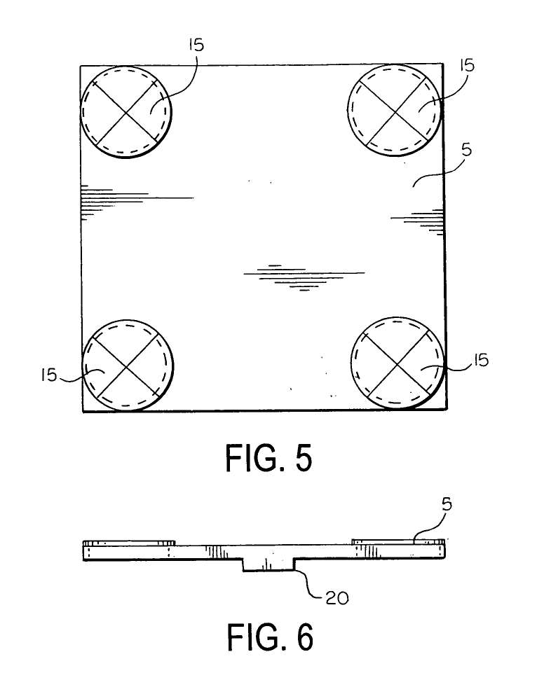

FIG. 5 is a top planar view of a cover for a main storage compartment according to one embodiment of the present invention. FIG. 6 is a planar side view of the cover of FIG. 5. The cover 5 is provided with flexible sealing elements 15 that are configured to be positioned over compartments 11 into which cleaning fluid cartridges 10 are placed so that toothbrushes 16 can be pushed through the sealing elements 15 and into the underlying cleaning fluid cartridges 10 and cleaning fluid therein as depicted in FIG. 1. The sealing elements 15 can be slit resilient rubber or plastic webs. In an alternative embodiment mentioned above, the cleaning fluid cartridges 10 can be provided with sealing elements 15 in which case the cover 5 can be eliminated or just provided with through openings over the compartments 11 containing the cleaning fluid cartridges 10.

The cover 5 can be with removable or openable by a hinged or sliding arrangement. FIG. 6 depicts a latch 20 that can be provided on one or more sides of the cover 5 to secure the cover 5 on the main storage compartment 2.

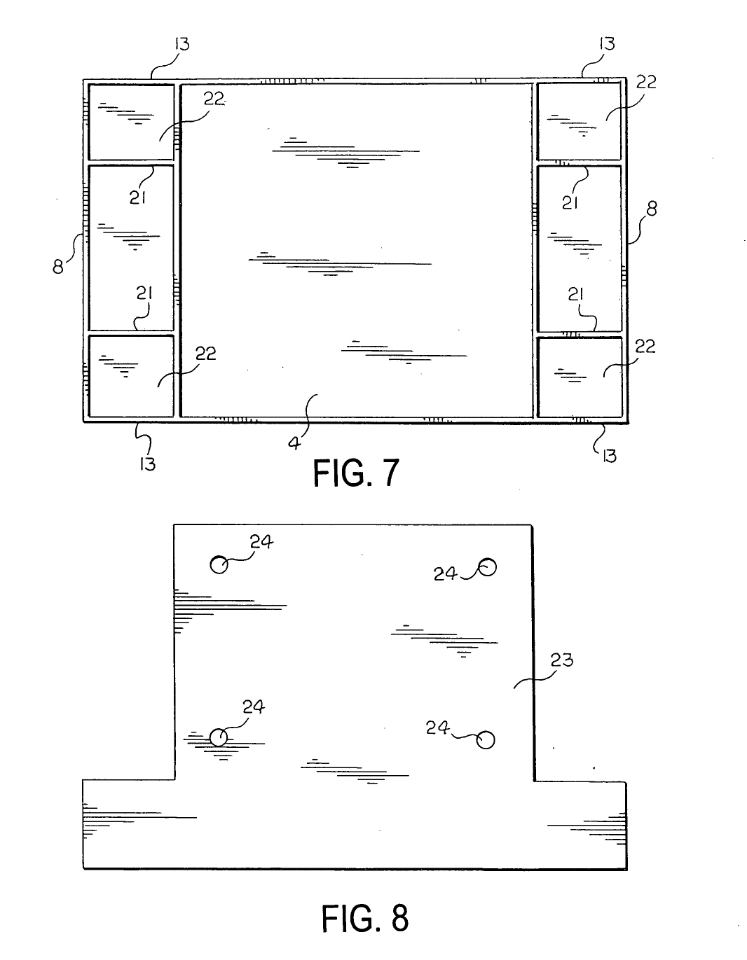

FIG. 7 is a top planar view of a base of a toothbrush storage unit according to one embodiment of the present invention. In the embodiment of the invention depicted in FIG. 7 extensions 6 of base 4 include outer walls 8, side walls 13 and divider walls 21 which together define compartments 22 that are sized to support the bases 9 of electric or battery operated toothbrushes.

FIG. 8 is a side planar view of an optional wall mountable side for the base of FIG. 7. The optional wall mountable side 23 includes through holes 24 through which fasteners such as nails, screws, etc. can be passed to mount the toothbrush storage unit to a wall or other vertical surface.

The toothbrush storage unit is formed by joining the main storage compartment 2 to the base 4. In alternative embodiments the main storage compartment 2 can include a separate base 4 and be configured to sit or connected into a registered position on the base 4. The use of a separate main storage compartment 2 and base 4 would are detachable allows for easier cleaning of the overall unit.

The components of the toothbrush storage unit can be made from a suitable rigid plastic material(s). When plastics materials are used they can be transparent, semi-transparent, translucent or opaque as desired. Alternatively some or all of the components could be made of a metal such as stainless steel. The cleaning fluid cartridges can be made of plastic or glass

The cleaning fluid can any of a number of germ-killing liquids including mouthwashes, antiseptic liquids, germicidal liquids, antibacterial liquids, a solution of dilute hypochlorite, a dilute solution of hydrogen peroxide or a combination thereof.

In use a cleaning fluid cartridge is opened and placed into one of the compartments of the main storage compartment. The cover is then closed over the main storage compartment. After a user has brushed his or her teeth and rinsed the toothbrush off, the user inserts the toothbrush through a sealing member, bristle end down, so that the bristles of the toothbrush are immersed below the surface of the cleaning liquid in the cleaning liquid cartridge. The toothbrush is stored in this position until the next use at which time, depending on the cleaning fluid used and the user's particular preference, the toothbrush can be removed from the storage and either used or first rinsed off and then used to brush the user's teeth.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

1. A toothbrush holder in combination with at least one disposable cleaning fluid cartridge:
the toothbrush holder comprising: a main storage compartment that is divided into at least one disposable cleaning fluid cartridge receiving compartment and a storage area, and a cover providing with at least one aperture that is aligned over the at least one disposable cleaning fluid cartridge receiving compartment; and
the at least one disposable cleaning fluid cartridge comprising a container complementary shaped and sized to be received in the at least one disposable cleaning fluid cartridge receiving compartment, an openable sealed end, and a cleaning solution within the at least one disposable cleaning fluid cartridge.

2. A toothbrush holder in combination with at least one disposable cleaning fluid cartridge according to claim 1, wherein the main storage compartment is divided into a plurality of disposable cleaning fluid cartridge receiving compartments, the at least one aperture comprises a plurality of apertures and the at least one disposable cleaning fluid cartridge comprises a plurality of disposable cleaning fluid cartridges.

3. A toothbrush holder in combination with at least one disposable cleaning fluid cartridge according to claim 1, wherein the at least one aperture of the cover is provided with a sealing member though which a toothbrush can be inserted.

4. A toothbrush holder in combination with at least one disposable cleaning fluid cartridge according to claim 1 wherein the at least one disposable cleaning fluid cartridge includes a sealing member adjacent the openable sealed end though which a toothbrush can be inserted.

5. A toothbrush holder in combination with at least one disposable cleaning fluid cartridge according to claim 1, wherein the toothbrush holder further comprises at least one compartment that is configured to receive a base of a battery operated or electric toothbrush.

6. A toothbrush holder in combination with at least one disposable cleaning fluid cartridge according to claim 5, wherein the at least one compartment configured to receive a base of a battery operated or electric toothbrush is located outside the main storage compartment.

7. A toothbrush holder in combination with at least one disposable cleaning fluid cartridge according to claim 1, wherein the storage area is configured to receive a plurality of the disposable cleaning fluid cartridges.

8. A toothbrush holder in combination with at least one disposable cleaning fluid cartridge according to claim 7, wherein the storage area is divided into sections.

9. A toothbrush holder in combination with at least one disposable cleaning fluid cartridge according to claim 1, wherein toothbrush holder includes a bracket by which it can be mounted to a vertical surface.

10. A toothbrush holder in combination with at least one disposable cleaning fluid cartridge according to claim 1, further including a base provided beneath the main storage compartment which base extends beyond at least one side of the main storage compartment.

11. A toothbrush holder in combination with at least one disposable cleaning fluid cartridge according to claim 10, wherein the base includes an outer wall that defines at least one compartment configured to receive a base of a battery operated or electric toothbrush.

12. A toothbrush holder in combination with at least one disposable cleaning fluid cartridge according to claim 1, wherein the main storage compartment and cover are made from plastic.

13. A toothbrush holder in combination with at least one disposable cleaning fluid cartridge according to claim 1, wherein the main storage compartment, cover and base are made from plastic.

14. A toothbrush holder in combination with at least one disposable cleaning fluid cartridge according to claim 1, wherein the cleaning solution is selected from the group consisting of mouthwashes, antiseptic liquids, germicidal liquids, antibacterial liquids, a solution of dilute hypochlorite, a dilute solution of hydrogen peroxide and a combination thereof.

15. A toothbrush holder in combination with at least one disposable cleaning fluid cartridge according to claim 1, wherein the at least one disposable cleaning fluid cartridge is made from one of either plastic or glass.
